(19) United States
(12) Patent Application Publication
(10) Pub. No.: US 2013/0306039 A1
(43) Pub. Date: Nov. 21, 2013

(54) Turbo Compressor By-Pass

(71) Applicant: International Engine Intellectual Property Company ,LLC, Lisle, IL (US)

(72) Inventors: John R. Zagone, Westmont, IL (US); Luis Carlos Cattani, Aurora, IL (US); Michael D. Bartkowicz, Oswego, IL (US)

(21) Appl. No.: 13/899,109

(22) Filed: May 21, 2013

Related U.S. Application Data
(60) Provisional application No. 61/649,773, filed on May 21, 2012.

(51) Int. Cl. F02B 37/16

(52) U.S. Cl. CPC F02B 37/16
USPC 123/562; 60/600

(57) ABSTRACT

A system is provided for boosting the pressure of air delivered to the intake manifold of an engine during a transient event. The system includes an air flow line that is configured to deliver air to an inlet of a low pressure compressor. The system also includes a high pressure compressor. The system further includes a bypass system having at least one bypass valve and a bypass line. The bypass system is configured to allow at least a portion of the air in the air flow line to bypass the low pressure compressor when the bypass valve is in an open position. The bypass valve may be actuated to an open position during transient events so as to increase the speed at which the pressure, and thus air flow mass, of air being supplied to an engine obtained desired levels.

### RELATED APPLICATIONS

This application claims priority to U.S. Patent Application No. 61/649,773, having a filing date of May 21, 2012, which is incorporated herein by reference in its entirety.

### BACKGROUND

Combustion engines, such as, for example, diesel and gasoline or petrol engines, may employ emission controls and/or systems that are configured to reduce the temperatures obtained during the combustion process. For example, some combustion engines may utilize exhaust gas recirculation (EGR) systems. EGR systems are configured to recirculate cooled engine exhaust gas back into the combustion chamber of the engine so as to reduce the volume of air and/or other combustible matter in the cylinder or the pre-combustion mixture. By replacing a portion of the oxygen or combustible material present during the combustion process with cooled, spent exhaust gas, EGR systems may reduce the temperatures generated during combustion events.

Reducing the temperature generated during a combustion event in the combustion chamber may reduce the quantity of certain by-products that are typically formed during the combustion event, such as, for example, nitrogen oxides (NOx). Thus, as emission requirements increase, the amount of cooled exhaust gas present in the combustion chamber during the combustion event may be increased. Yet, the resulting decrease in the temperature of the exhaust gas exiting the combustion chamber may adversely impact the performance of components downstream of the combustion chamber that rely on the elevated temperatures of the exhaust gas. Additionally, by increasing the quantity of exhaust gas that the EGR system recirculates back to the intake manifold of the engine also decreases the quantity of exhaust gas used to drive components, such as turbines, that are downstream of the engine.

For example, modern diesel engines often use turbochargers that are powered using the flow of heated exhaust gas released from the combustion chamber, and the associated pressure differentials such heated exhaust gases may provide across the turbines. For example, some engines use two stage turbochargers in series, such as a high pressure turbine upstream of a low pressure turbine, that are used power high and low pressure compressors. Such compressors are typically used to generate a wide range of air flow needed to satisfy air flow requirements for combustion events and the EGR system during various engine and/or vehicle operating conditions. Moreover, in increasing the pressure of the air delivered to the engine, such compressors increase the density, and thus mass, of the air flow delivered to the engine. To adequately match the mass air flow requirements for such operating conditions, the use of two stage turbochargers in series often requires that the low pressure turbine and associated low pressure compressor be larger than the high pressure turbine and its associated high pressure compressor.

However, by increasing the quantity of exhaust gas used by the EGR system and in the combustion event causes a reduction of the quantity and temperature of exhaust gas used to drive the high and low pressure turbines. Such decreases may, under certain vehicle operations, such as during transient conditions, result in insufficient mass flow of the exhaust gas to power the larger low pressure turbine. Additionally, the resulting flow and inertia effects of the underpowered larger low pressure turbocharger may impede the ability of the low pressure stage compressor to supply boost pressure during low power and low speed transient operation of the vehicle's engine. Attempts to overcome such issues have included engine calibration, including changes in fuel quantity of timing of fuel used during the transient event and the use of variable-geometry turbochargers (VGT). Yet, such VGTs have shown to be inadequate in addressing the transient performance issues for two stage turbocharger systems.

### BRIEF SUMMARY

According to an embodiment, a system is provided for boosting the pressure of air delivered to the intake manifold of an engine during a transient event. The system includes an air flow line that is configured to deliver air to an inlet of a low pressure compressor that is configured to compress the delivered air to a first pressure. The system also includes a high pressure compressor that is configured to receive air compressed by the low pressure compressor. The high pressure compressor is configured to compress the received air to a second pressure, with the air that is compressed by the high pressure compressor being delivered to the intake manifold of the engine. The system also includes a bypass system having a bypass valve and a bypass line. The bypass system is configured to allow at least a portion of the air in the air flow line to bypass the low pressure compressor when the bypass valve is in an open position.

According to another embodiment, a system is provided for boosting the pressure of air delivered to the intake manifold of an engine during a transient event. The system includes an air flow line. A low pressure compressor is operably connected to the air flow line. Additionally, a high pressure compressor is operably connected to the air flow line downstream of the low pressure compressor. The system also includes a bypass system having at least one bypass valve and a bypass line. The bypass system is configured to divert air from the air flow line around the low pressure compressor. Further, the bypass line is configured to deliver the diverted air downstream of the low pressure compressor to allow the diverted air to be compressed by the high pressure compressor.

According to a further embodiment, a method is provided for boosting the pressure of air delivered to the intake manifold of an engine during a transient event. The method includes sensing a first pressure of air entering a low pressure compressor along an air flow path. A second pressure of air exiting the low pressure compressor is also sensed. The method also includes actuating a bypass valve to allow at least a portion of the air in the air flow line to bypass the low pressure compressor. The air that bypassed the low pressure compressor is delivered to a high pressure compressor. Further, bypass valve is actuated to stop air in the air flow line from continued to bypass the low pressure compressor.

### BRIEF DESCRIPTION OF SEVERAL VIEWS OF THE DRAWINGS

FIG. 1 is a schematic of an engine system having a parallel bypass system for bypassing a low pressure compressor and an interstage cooler.

FIG. 2 is a schematic of an engine system having a three-way bypass system for bypassing a low pressure compressor and an interstage cooler.

FIG. 3 is a schematic of an engine system.

FIG. 4 is a graphical representation illustrating the effect of using a bypass system to bypass a low pressure compressor during transient events.

### DETAILED DESCRIPTION

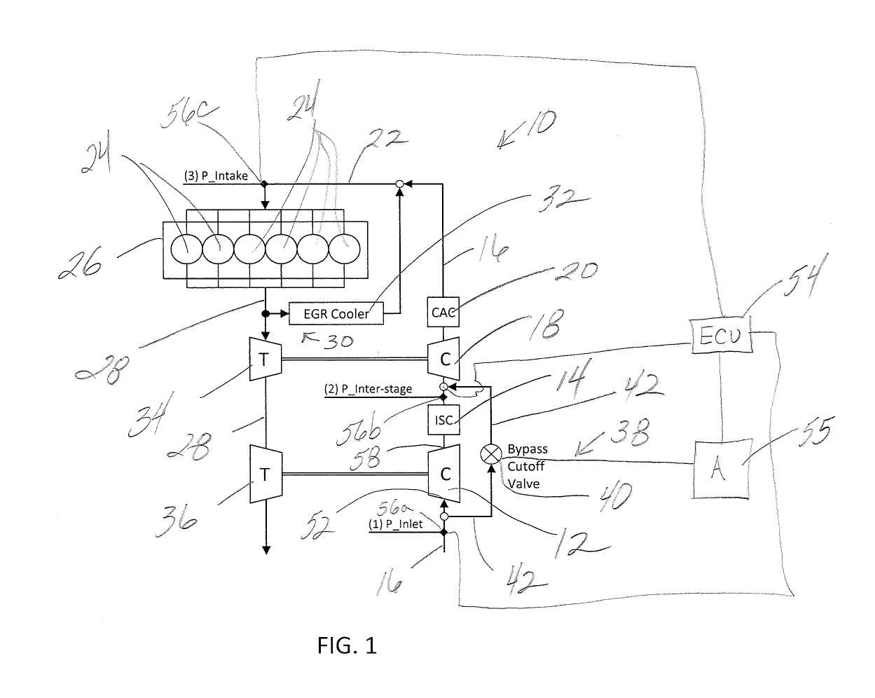

FIG. 1 is schematic of an engine system 10 having a parallel bypass system 38 that is configured to divert air around a low pressure compressor 12 and an interstage cooler 14. As shown, air for use in the operation of the engine system 10, such as for use during the internal combustion process, may flow along an air flow line or line 16 that includes various hoses and/or tubes. For example, as shown in FIG. 1, air passes along a first portion of the air flow line 16 and into the low pressure compressor 12 before flowing along a second portion of the air flow line 16 to the interstage cooler 14. The air then flows through a high pressure compressor 18 and high pressure charged air cooler 20 before flowing through the another portion of the air flow line 16 to an intake manifold 22.

The air may flow through the intake manifold 22 and to combustion chambers 24 of the engine 26, where the air may be used in a combustion event(s) that is used to displace the pistons of the engine 26, thereby transmitting the force of the combustion event(s) into mechanical power that is used to drive the drivetrain of the associate vehicle. The resulting hot exhaust gas 31 produced by the combustion event(s) may flow out of the combustion chambers 24 from the engine 26 through an exhaust port(s) and along an exhaust gas flow path 28.

At least a portion of the hot exhaust gas from the engine 26 may be diverted from the exhaust gas flow path 28 and to an exhaust gas recirculation (EGR) system 30. The EGR system 30 is configured to recirculate the diverted exhaust gas back to the intake manifold 22. However, before the EGR system 30 recirculates exhaust gas, the exhaust gas is typically cooled by an EGR cooler 32 or heat exchanger. A coolant, such as antifreeze mixtures or non-aqueous solutions, among others, typically circulates through the EGR cooler 32. According to some designs, the coolant and/or the heated exhaust gases flow through tubes, a jacket, or other forms of conduits in the EGR cooler 32. The EGR cooler 32 may be configured so that heated exhaust gases flow around and/or over tubes containing flowing coolant, or vice versa, causing heat from the exhaust gas to be transferred to the coolant. The EGR cooler 32 may also include fins that assist with the transfer of heat from the exhaust gas to the coolant. After exiting the EGR cooler 32, the cooled engine coolant is delivered to the intake manifold 22, thereby allowing the cooled exhaust gas to enter into the combustion chambers 24 with the air that was delivered to the intake manifold 22 through the air flow line 16.

Exhaust gas 31 that is not diverted to the EGR system 30 may continue to flow along the exhaust gas flow path 28 and be delivered to a high pressure turbine 34. The exhaust gas, and the heat entrained therein, may then at least assist in driving the high pressure turbine 34. Power generated by the high pressure turbine 34 may at least in part be used to power or drive the high pressure compressor 18.

Exhaust gas exiting the high pressure turbine 34 may then flow along the exhaust gas flow path 28 to a low pressure turbine 36. The low pressure turbine 36 may also be configured to be driven by the exhaust gas, and the heat entrained therein. Additionally, operation of the low pressure turbine 36 may be used to power or drive the low pressure air compressor 12. Exhaust gas exiting the low pressure turbine 30 may then be released from the exhaust gas flow path 28. For example, the exhaust gas may be outputted from the low pressure turbine 30 to an exhaust gas after-treatment system, an ancillary system that continues to utilize heat entrained in the exhaust gas, and/or into the environment.

Typically, during normal operation of the engine system 10, the high and low pressure compressors 12, 18 generate a wide range of air flow needed to satisfy air flow requirements for combustion events and the EGR system 30 during various engine 26 and/or vehicle operating conditions. However, during certain transient conditions, rather than compressing air, and thereby elevating the pressure of the air, for a period of time a pressure drop may be experienced across the low pressure compressor 12. For example, when the engine system 10 is coming off an idle condition, a sudden request for a relatively large amount of power from the engine 26 may result in a sudden need for the delivery of a relatively high air mass flow into the engine 26. Under such circumstances, the low pressure compressor 12 may, at least temporarily, experience a drop in air pressure across the low pressure compressor 12 as air is suddenly being pulled into the high pressure compressor 18. Additionally, in such situations, the mass flow of exhaust gas being delivered to the relatively large low pressure turbine 36, as well as the temperature of that delivered exhaust gas, may provide insufficient power to drive the low pressure turbine 36 in a manner that allows the relatively large low pressure compressor 12 to elevate the pressure of air passing through the compressor 12. According to such situations, the engine system 10 may include a bypass system 38 that is configured to, at least temporarily, divert air from or around the low pressure compressor 12.

For example, FIG. 1 illustrates the use of a bypass system 38 that is configured to be in parallel with the both the low pressure compressor 12 and the interstate cooler 14. As shown, the bypass system 38 includes a bypass valve 40 and a bypass line 42. In the embodiment illustrated in FIG. 1, when the bypass valve 40 is in a closed position air is allowed to flow along the air flow line 16 to, and through, the inlet of the low pressure compressor 12. However, when the bypass valve 40 is in a parallel configuration as shown in FIG. 1 and the bypass valve 40 is in an open position, at least a portion of the air approaching the low pressure compressor 12 may be diverted through the bypass system 38 so as to bypass the low pressure compressor 12 and the interstage cooler 14, while the remainder of the air is delivered to, and through, the inlet 52 of the low pressure compressor 12.

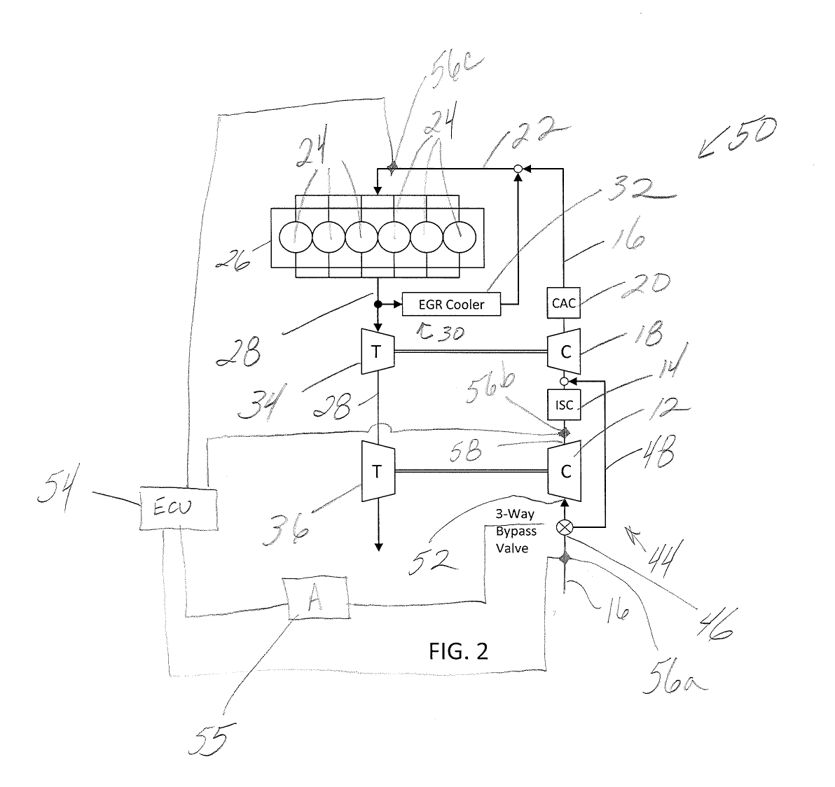

FIG. 2 illustrates an engine system 50 similar to that of FIG. 1, but in which the bypass system 44 includes a bypass valve 46 that is in series with the low pressure compressor 12. In such a configuration, when the bypass valve 46 is in a closed position, air approaching the low pressure compressor 12 through the air flow line 16 may again pass through the bypass valve 46 and onto, and through, the inlet 52 of the low pressure compressor 12. However, when the bypass valve 46 is in an open position, air in the air flow line 16 is prevented from being delivered to the inlet 52 of the low pressure compressor 12. Instead, with bypass valve 46 in the open position, air is diverted into the bypass line 48 so that the air bypasses the low pressure condenser 12 and interstage cooler 14, and is instead delivered through the bypass line 48 to the high pressure condenser 18.

The opening or closing of the bypass valve 40, 46 may be controlled by an engine control unit or module (ECU) 54. The ECU 54 may be operably connected to sensors that provide information to the ECU 54 reflecting conditions of air along the air flow line 16. For example, referencing FIG. 1, the engine system 10 may include pressure sensors 56a, 56b, 56c that are used to detect air pressure at various positions along the air flow line 16. In the illustrated embodiment, a first pressure sensor 56a is positioned upstream of the low pressure compressor 12 so as to detect the pressure of the air at or being delivered to the inlet 52 of the low pressure compressor 12. A second pressure sensor 56b is positioned downstream of the low pressure compressor 12. As shown in FIGS. 1 and 2, according to certain embodiments, the second pressure sensor 56b may be positioned at or around an outlet 58 of the low pressure condenser 12 or downstream of the interstage cooler 14. A third pressure sensor 56c may be positioned to sense the pressure of air, with or without re-circulated exhaust gas, that is at or around the intake manifold 22 of the engine 26. While the illustrated embodiments demonstrate the use of three pressure sensors 56a, 56b, 56c, any different number of pressure sensors may be employed. Further, other sensors may be used with, or in lieu of, the pressure sensors 56a, 56b, 56c, including, for example, flow and/or temperature sensors. The ECU 54 may include logic or a control strategy that utilizes the information provided by at least the sensors 56a, 56b, 56c to determine when, and for how long, the bypass valve 40, 46 should be in an open and/or closed position. When the bypass valve 40, 46 is to be changed from an open to a closed position, and vice versa, the ECU 54 may provide a signal used to operate an actuator 55 that is operably connected to the bypass valve 40, 46. A variety of different types of actuators may be used for actuation of the bypass valve 40, 46, including, for example, electric, pneumatic/electro-pneumatic, and electro-hydraulic actuators.

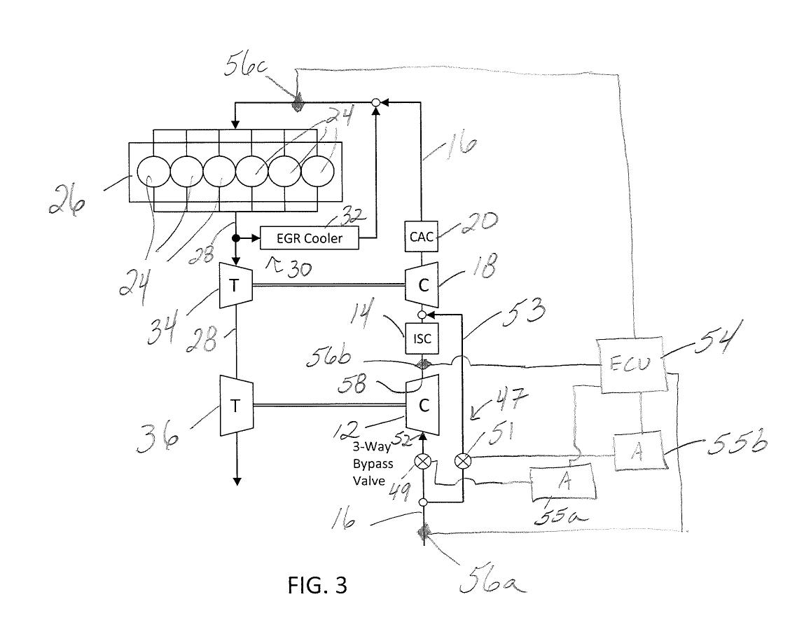

As illustrated in FIGS. 1 and 2, the bypass valve 40, 46 may be in a variety of different locations that allow at least a portion of the air in the air flow line 16 to be diverted away from the low pressure compressor 12. Additionally, according to certain embodiments, the bypass system may include more than one bypass valve 40, 46. For example, FIG. 3 illustrates an engine system 45 having a bypass system 47 that includes a first bypass valve 49 and a second bypass valve 51. As shown, the first bypass valve 49 is positioned along the air flow line 16 upstream of the low pressure compressor 12. Accordingly, the first bypass valve 49 may be actuated by an actuator 55a to either allow or prevent the flow of air along the air flow line 16 to the inlet 52 of the low pressure compressor 12. Additionally, the second bypass valve 51 may be actuated by an actuator 55b to either allow or prevent at least a portion of the air in the air flow line 16 to flow through the bypass system 47 rather than through the low pressure compressor 12. For example, when the first bypass valve 49 is positioned so as to allow air to flow into the low pressure compressor 12, the second by pass valve 51 may also be positioned to allow at least a portion of the air in the air flow line 16 to flow through the bypass system 47, and be diverted around the low pressure compressor 12. Alternatively, when the first bypass valve 49 is positioned to block air from flowing into the low pressure compressor 12, the second by pass valve 51 be positioned to allow the air in the air flow line 16 to be diverted from the low pressure compressor 12, and instead flow through the bypass system 47. Conversely, the second bypass valve may also be positioned to prevent the flow of air through the bypass system 47, and thereby prevent air from being diverted from the low pressure compressor 12.

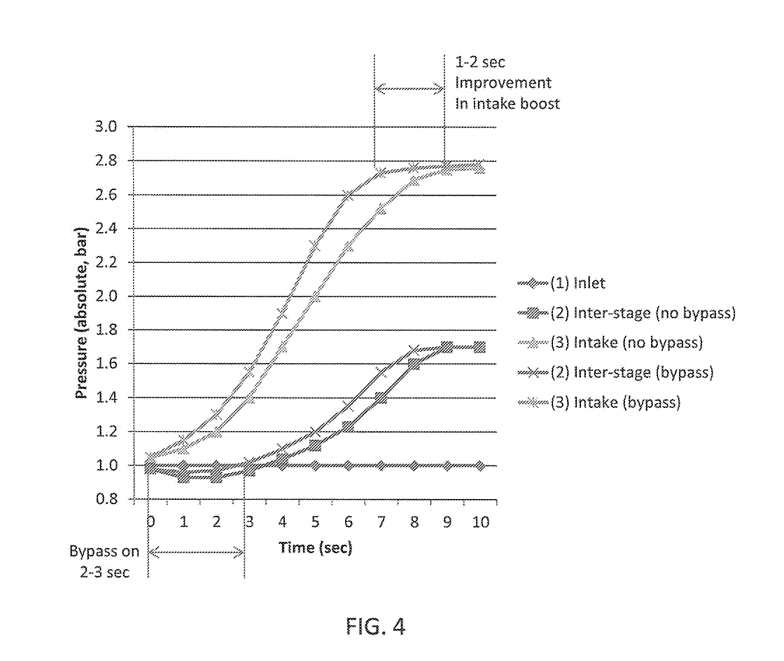

FIG. 4 is a graphical representation illustrating the effect of using a bypass system 10, 50 to bypass a low pressure compressor 12 during transient events. As shown, the pressure sensed by the first sensor 56a is relatively constant during the transient event. However, during the approximately the first 2 to 3 seconds of the transient event, the second pressure sensor 56b may sense a pressure that is lower than the pressure sensed by the first pressure sensor 56a, indicating a pressure drop across the low pressure condenser 12. However, according to the example illustrated in FIG. 4, during this initial transient period (extending from 0 seconds to approximately 2 or 3 seconds), when the second pressure sensor 56b senses a pressure below that sensed by the first pressure sensor 56a, the bypass valve 40, 46 may be in an open position so that at least a portion of the air in the air flow line 16 is diverted into the bypass system 38, 44 and around the low pressure condenser 12.

The duration that the bypass valve 40, 46 remains in the open position may be determined by a variety of factors. For example, in the example illustrated in FIG. 4, the bypass valve 40, 46 may be changed from being in an open position to a closed position by the ECU 54 and associated actuator 55 when the pressure sensed by the second pressure sensor 56b is near, at, or above the pressure sensed by the first pressure sensor 56a. Further, in the present example, the bypass valve 40, 46 may be closed at about the 2 to 3 second position in the chart illustrated in FIG. 4. After such time period, the low pressure compressor 12 may deliver an adequate boost to the mass flow of air outputted by the low pressure compressor 12 to overcome the need for the bypass system 38, 48.

By at least temporarily bypassing the low pressure compressor 12, a relatively larger air flow mass is delivered to the engine 26 during the majority of the transient event than is achieved by an engine system that does not have a bypass system 38, 44. Moreover, by using a bypass system 38, 44, the pressure of the air delivered to the engine 26 obtains a desired level of around 2.8 bars approximately 1 to 2 seconds before the engine system not having the by-pass system reaches such levels. By decreasing the time period needed for the pressure of air being delivered to the engine 26 to obtain desired operating levels, the bypass system 38, 44 is able to provide a pressure boost that reduces the time period of the transient event. Such decreases in transient time may at least assist in improving engine performance, including, for example, the responsiveness of the engine 26 to off-idle demands of the driver.

1. A system for boosting the pressure of air delivered to the intake manifold of an engine during a transient event, the system including:
an air flow line configured to deliver air to an inlet of a low pressure compressor, the low pressure compressor configured to compress the delivered air to a first pressure;
a high pressure compressor configured to receive air compressed by the low pressure compressor, the high pressure compressor configured to compress the received air to a second pressure, the air compressed by the high pressure compressor being delivered to the intake manifold of the engine; and
a bypass system having a bypass valve and a bypass line, the bypass system configured to allow at least a portion of the air in the air flow line to bypass the low pressure compressor when the bypass valve is in an open position.

2. The system of claim 1, wherein the bypass line is configured to deliver air that has bypassed the low pressure compressor to a portion of the air flow line upstream of the high pressure compressor.

3. The system of claim 2, wherein the bypass valve is positioned along the air flow line upstream of the low pressure compressor, the bypass valve configured to prevent the flow of air along the air flow line to the inlet of the low pressure compressor when the bypass valve is in an open position.

4. The system of claim 2, wherein the bypass line has a first end and a second end, the first end being operably connected to the air flow line upstream of the low pressure compressor, the second end being operably connected to the air flow line downstream of the low pressure compressor, and wherein the bypass valve is position between the first and second ends along the bypass line.

5. The system of claim 2, wherein the bypass valve includes a first bypass valve and a second bypass valve, the first bypass valve being positioned long the air flow line, the second bypass valve being positioned between a first end and a second end of the bypass line.

6. The system of claim 2, wherein the bypass line delivers the diverted air back to the air flow line at a location downstream of an interstage cooler.

7. The system of claim 1, further including a plurality of pressure sensors positioned along the air flow line, the plurality of pressure sensors providing information used by an electronic control unit to determine whether to actuate the bypass valve.

8. A system for boosting the pressure of air delivered to the intake manifold of an engine during a transient event, the system including:
an air flow line;
a low pressure compressor operably connected to the air flow line;
a high pressure compressor operably connected to the air flow line downstream of the low pressure compressor;
a bypass system having at least one bypass valve and a bypass line, the bypass system configured to divert air from the air flow line around the low pressure compressor, the bypass line being configured to deliver the diverted air downstream of the low pressure compressor to allow the diverted air to be compressed by the high pressure compressor.

9. The system of claim 8, wherein the bypass line delivers the diverted air back to the air flow line at a location downstream of an interstage cooler.

10. The system of claim 9, wherein at least one of the at least one bypass valve is positioned along the air flow line upstream of the low pressure compressor and configured to prevent the flow of air along the air flow line to the inlet of the low pressure compressor when the bypass valve is in an open position.

11. The system of claim 9, wherein the bypass line has a first end and a second end, the first end being operably connected to the air flow line upstream of the low pressure compressor, the second end being operably connected to the air flow line downstream of the low pressure compressor, and wherein the at least one bypass valve is position between the first and second ends along the bypass line.

12. The system of claim 9, wherein the at least one bypass valve includes a first bypass valve and a second bypass valve, the first bypass valve being positioned long the air flow line, the second bypass valve being positioned between a first end and a second end of the bypass line.

13. A method for boosting the pressure of air delivered to the intake manifold of an engine during a transient event, the method including:
sensing a first pressure of air entering a low pressure compressor along an air flow path;
sensing a second pressure of air exiting the low pressure compressor;
actuating a bypass valve to allow at least a portion of the air in the air flow line to bypass the low pressure compressor;
delivering the air that bypassed the low pressure compressor to a high pressure compressor; and
actuating the bypass valve to stop air in the air flow line from bypassing the low pressure compressor.

14. The method of claim 13, wherein the step of actuating a bypass valve to allow at least a portion of the air to bypass the low pressure compressor is initiated after determining, by an engine control unit, that the sensed second pressure is a predetermined amount lower than the sensed first pressure.

15. The method of claim 13, wherein the step of actuating the bypass valve to stop air from bypassing the low pressure compressor is initiated when the sensed second pressure is approximately equal to the sensed first air pressure.
